(19) United States
(12) Patent Application Publication
(10) Pub. No.: US 2004/0156058 A1
(43) Pub. Date: Aug. 12, 2004

(54) Image forming circuit, image forming apparatus having the same, and image forming method

(75) Inventor: Kazumasa Takada, Shizuoka-Ken (JP)

Correspondence Address: FOLEY AND LARDNER, SUITE 500, 3000 K STREET NW, WASHINGTON, DC, 20007, US

(73) Assignee: TOSHIBA TEC KABUSHIKI KAISHA

(21) Appl. No.: 10/361,020

(22) Filed: Feb. 10, 2003

(51) Int. Cl. H04N 1/60; H04N 1/64

(52) U.S. Cl. 358/1.9; 358/519; 358/523; 358/521; 358/524

(57) ABSTRACT

In an image forming circuit, a color image forming apparatus using it, and an image forming method according to this invention, the number of LUTs or RAMs which require different settings for four colors is decreased to two from four in the prior art. By alternately using the two LUTs or RAMs, the capacity, power consumption, and cost can be reduced while required performance such as the processing speed is maintained.

### BACKGROUND OF THE INVENTION

Image forming apparatuses such as a color copying machine and color printer which form color images have look-up tables (to be referred to as LUTs hereinafter) for gamma (to be referred to as γ hereinafter) correction conversion for obtaining γ correction data from input image data and toner density conversion for calculating a toner density consumed in actually printing γ-corrected image data. These LUTs are comprised of RAMs, registers, or the like. The image forming apparatus further uses a RAM in order to save, e.g., a pattern for generating an internal test pattern.

Color image formation requires different image processes and the like for four colors: yellow (to be referred to as Y hereinafter), magenta (to be referred to as M hereinafter), cyan (to be referred to as C hereinafter), and black (to be referred to as K hereinafter). For this purpose, the conventional image forming apparatus adopts four LUTs and four RAMs dedicated to the respective colors.

According to the prior art, dedicated large-capacity LUTs and RAMs are necessary for the respective colors. LUTs and RAMs formed from image processing ASICs increase the number of gates and the capacity, resulting in high power consumption and a high manufacturing cost.

### SUMMARY OF THE INVENTION

The present invention has been made in consideration of the above situation, and has as its object to provide an image forming circuit capable of decreasing the total capacity of LUTs and RAMs and contributing to reduction in power consumption and cost, an image forming apparatus having the image forming circuit, and an image forming method.

According to the present invention, an image forming circuit which receives input image data, performs image processing necessary to form a color image, and outputs print image data necessary for printing, comprises

an image processor which receives the image data, and performs γ conversion processing for respective Y, M, C, and K colors by using a γ conversion LUT rewritten in accordance with the respective colors, and

a print area controller which receives the image data having undergone the γ conversion processing, and generates and outputs the print image data.

According to the present invention, an image forming circuit which receives input image data, performs image processing necessary to form a color image, and outputs print image data necessary for printing, comprises

an image processor which receives the image data, and performs γ conversion processing for respective Y, M, C, and K colors by alternately using two γ conversion LUTs, and

a print area controller which receives the image data having undergone the γ conversion processing, and generates and outputs the print image data.

It is also possible that the image forming circuit further comprises a density converter which receives the print image data, and uses two density conversion LUTs for density conversion processing necessary to obtain a consumed toner amount, and the density converter alternately uses the two density conversion LUTs when performing density conversion processing for the respective Y, M, C, and K colors.

It is also possible that the image forming circuit further comprises a test pattern generator which uses two test pattern saving RAMs to generate a test pattern necessary to print a test pattern, and outputs the test pattern as the image data to the image processor, and the test pattern generator alternately uses the two test pattern saving RAMs when generating test patterns in the respective Y, M, C, and K colors.

According to the present invention, an image forming apparatus comprises a scanner which scans an original and outputs image data, an image forming circuit which receives the image data, performs image processing necessary to form a color image, and outputs print image data necessary for printing, and a laser scan unit which receives the print image data and scans a laser beam,

the image forming circuit having

an image processor which receives the image data, and performs γ conversion processing for respective Y, M, C, and K colors by alternately using two γ conversion LUTs, and

a print area controller which receives the image data having undergone the γ conversion processing, and generates and outputs the print image data.

According to the present invention, an image forming method of receiving input image data, performing image processing necessary to form a color image, and outputting print image data necessary for printing, comprises the steps of receiving the image data to perform γ conversion processing for respective Y, M, C, and K colors by alternately using two γ conversion LUTs, and

receiving the image data having undergone the γ conversion processing to generate and output the print image data.

### BRIEF DESCRIPTION OF THE DRAWINGS

FIG. 1 is an outer appearance view showing the schematic arrangement of an image forming apparatus according to an embodiment of the present invention;

FIGS. 2A, 2B, and 2C are explanatory views showing the relationship between the RAM capacity and the image data processing time in a conventional four-LUT arrangement, a two-LUT arrangement, and a one-LUT arrangement;

FIG. 3 is a block diagram showing the arrangement of an image forming circuit according to the embodiment of the present invention;

FIG. 4 is a flow chart showing a sequence of alternately switching and using two LUTs in an image forming method according to the embodiment; and

FIG. 5 is a timing chart showing the sequence.

### DESCRIPTION OF THE PREFERRED EMBODIMENTS

A preferred embodiment of the present invention will be described below with reference to the accompanying drawings.

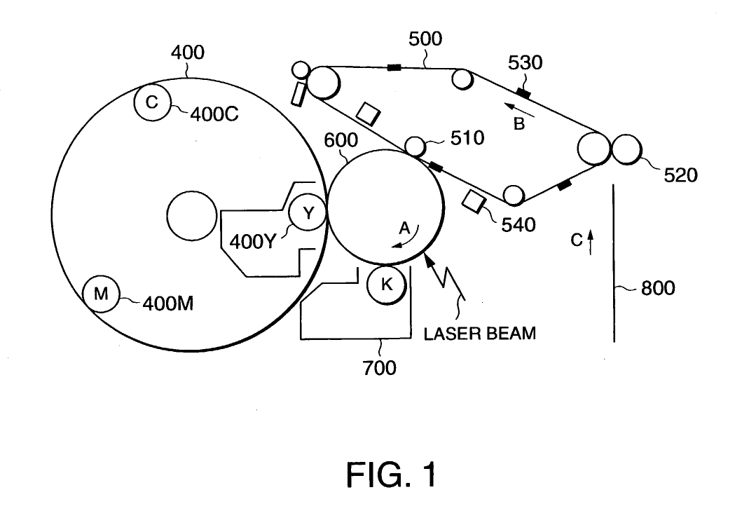

FIG. 1 shows the schematic arrangement of an image forming apparatus according to the embodiment. This apparatus is a 4-pass color electrophotographic printing apparatus using an intermediate transfer member.

In a color developing unit 400, a Y developing unit 400Y, M developing unit 400M, and C developing unit 400C sequentially rotate. From these developing units and a black developing unit 700, Y, M, C, and K color toners are sequentially deposited on the surface of a drum 600. The surface of the drum 600 is irradiated with a laser beam in accordance with image data of the respective colors, sequentially forming Y, M, C, and K latent images on the drum 600. A marker 530 representing a position is formed on an intermediate transfer belt 500. The position of the marker 530 is detected by a sensor 540, and the intermediate transfer belt 500 is driven in accordance with the detection result. Every time each color latent image is formed on the drum 600, the color latent images are sequentially formed on the intermediate transfer belt 500 by a primary transfer roller 510. As a result, color latent images in the four colors are superposed on the intermediate transfer belt 500, and the formed latent images are transferred onto a transfer sheet 800 by a secondary transfer roller 520.

In this fashion, latent images are sequentially formed and transferred for the respective colors. Different processes need not be simultaneously performed for the respective colors, and suffice to be sequentially performed.

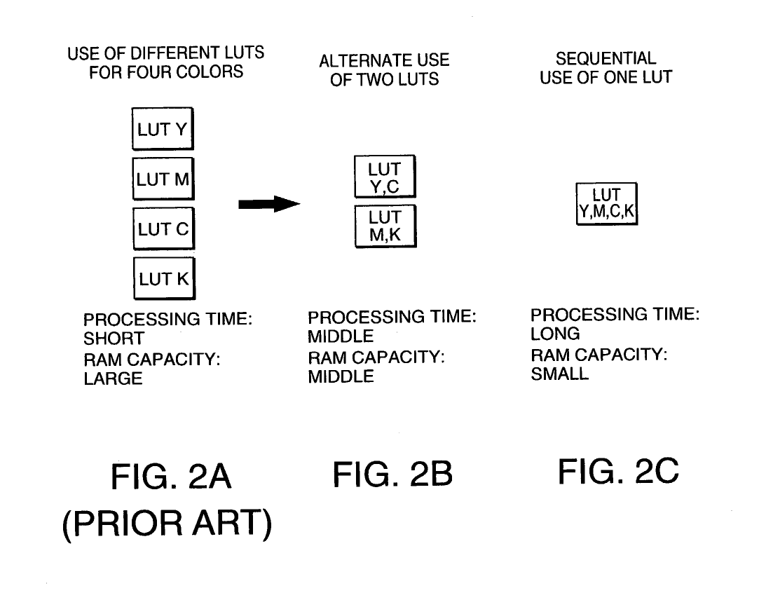

In the prior art, as shown in FIG. 2A, four γ correction conversion LUTs, four toner density conversion LUTs, and four test pattern saving RAMs are arranged and dedicated to the respective colors.

The four-LUT/RAM arrangement shortens the processing time, but increases the total capacity and cost.

As described above, processes for the respective colors suffice to be sequentially executed. As shown in FIG. 2C, one LUT and one RAM are used commonly to the respective colors. The contents of the LUT and RAM are reset and used for processing of each color. This can reduce the total capacity of the LUT and RAM to ¼.

The one-LUT/RAM arrangement reduces the capacity, but prolongs the processing time. When the transition time from processing of a given color to that of another color is short, two LUTs are alternately used, as shown in FIG. 2B. This arrangement can reduce the capacity to ½ in comparison with the conventional 4-LUT arrangement, and can also shorten the processing time.

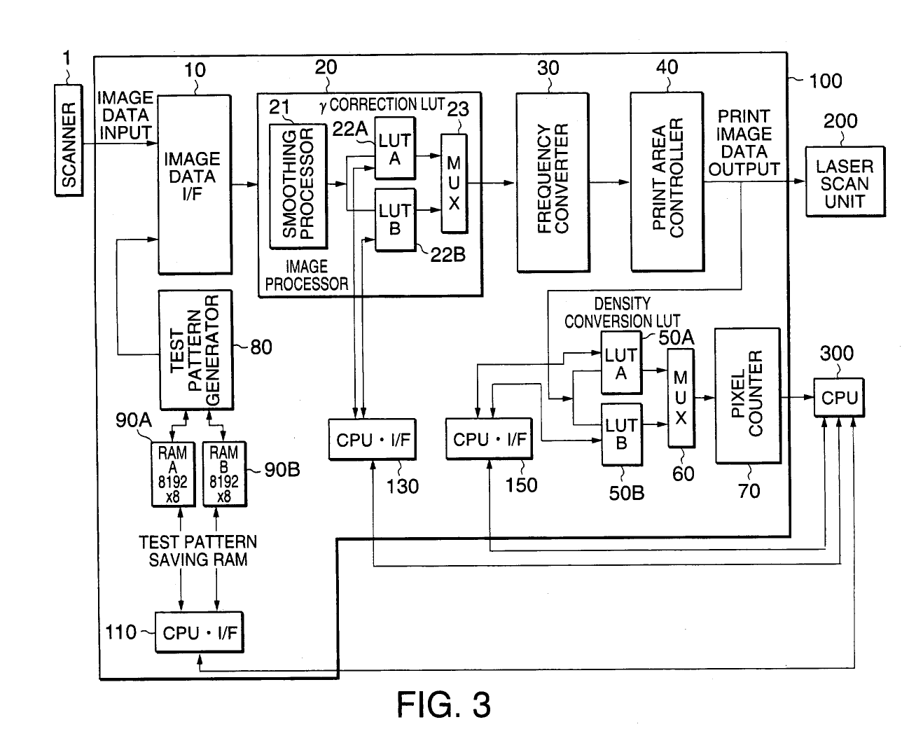

FIG. 3 shows the arrangement of an image forming circuit according to the embodiment.

A scanner 1 scans an original and generates an image signal. The generated image signal is supplied to an image forming circuit 100.

Note that the image signal may be print data sent from an external computer (not shown) via a network.

The image forming circuit 100 comprises an image data interface (to be referred to as an I/F hereinafter) 10; an image processor 20 having a smoothing processor 21, γ correction LUTs 22A and 22B, and a multiplexer 23; a frequency converter 30; a print area controller 40; density conversion LUTs 50A and 50B; a multiplexer 60; a pixel counter 70; a test pattern generator 80; test pattern saving RAMs 90A and 90B; and CPU I/Fs 110, 130, and 150.

The image data I/F 10 receives image data from the scanner 1.

The image processor 20 adjusts the image quality of the received image data. More specifically, the image data undergoes smoothing processing by the smoothing processor 21, and is converted into γ correction data of the image data by using the γ correction LUTs 22A and 22B. The γ correction data generated by the LUTs 22A and 22B are alternately switched and output by the multiplexer 23.

The frequency converter 30 converts the transfer rate of the image data output from the image processor 20 into a print transfer rate (clock).

The print area controller 40 reflects the margin setting and the like on the image data output from the frequency converter 30, and outputs print data of only a data range subjected to actual printing. The print data is supplied to a laser scan unit (LSU) 200, and used to emit a laser beam onto the drum 600.

The print data is supplied to the density conversion LUTs 50A and 50B where data representing toner densities are generated and alternately output via the multiplexer MUX 60. The pixel counter 70 receives the toner density data alternately output from the LUTs 50A and 50B, counts the toner amount used in actual printing, and outputs the count value to a CPU 300. Based on this count value, the CPU 300 displays the toner use amount on an operation panel (not shown) or the like.

If a test pattern need be printed, the test pattern saving RAMs 90A and 90B supply data necessary to generate a test pattern to the test pattern generator 80. A test pattern generated in the test pattern generator 80 is supplied to the image data I/F 10, and the above-described processing is executed.

In setting, the LUTs 22A and 22B, LUTs 50A and 50B, RAMs 90A and 90B are switched as follows. The CPU 300 supplies a control signal necessary for switching and data to be written to the LUTs and RAMs via the CPU I/Fs 110, 130, and 150. The CPU 300 directly writes data in corresponding data areas of the LUTs 22A and 22B, LUTs 50A and 50B, and RAMs 90A and 90B on the basis of addresses assigned in advance.

This embodiment employs the two, data conversion LUTs 22A and 22B for γ correction of image data, the two, toner density conversion LUTs 50A and 50B, and the two, test pattern saving RAMs 90A and 90B.

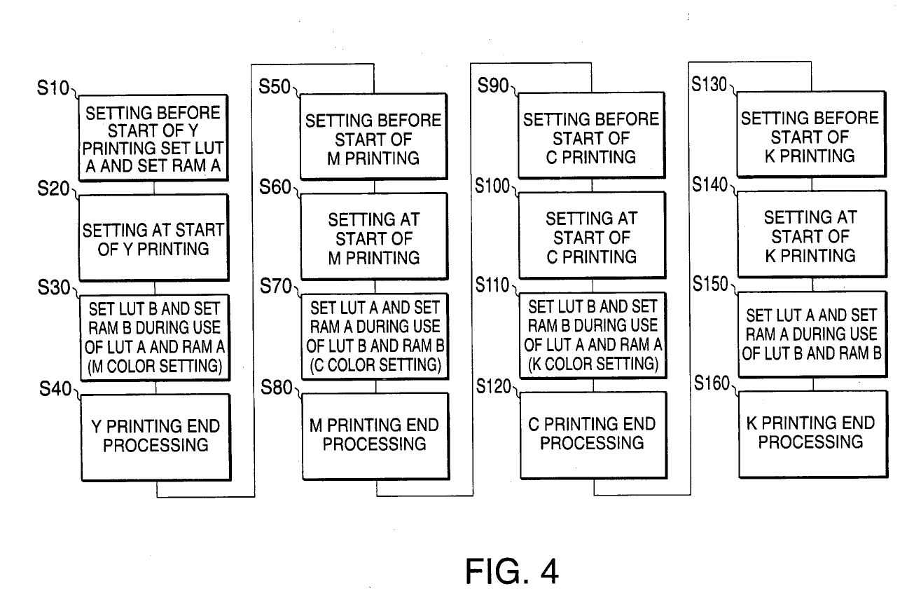

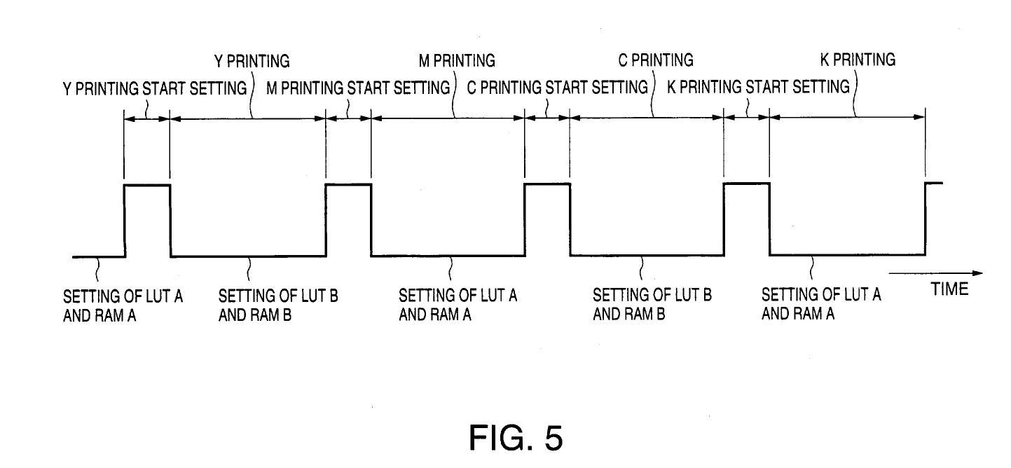

A processing sequence in an image forming method alternately using these LUTs and RAMs according to the embodiment will be explained with reference to the flow chart of FIG. 4 and the timing chart of FIG. 5 showing the sequence.

In step S10, LUT A (LUT 22A and LUT 50A) and RAM A (RAM 90A) are set (data are written or rewritten) before the start of Y printing.

In step S20, settings necessary to start Y printing are done. More specifically, these settings include the time until the CPU 300 outputs image data after the image forming circuit 100 issues a request to the CPU 300 in order to output image data used in Y printing.

In step S30, LUT A and RAM A are used to execute Y printing. During this period, LUT B (LUT 22B and LUT 50B) and RAM B (RAM 90B) used in the next M printing are set (data are written or rewritten).

In step S40, Y printing end processing is performed.

In step S50, settings before the start of M printing are done.

In step S60, settings necessary to start M printing are done.

In step S70, LUT B and RAM B are used to execute M printing. During this period, LUT A and RAM A used in the next C printing are set (data are written or rewritten).

In step S80, M printing end processing is performed.

In step S90, settings before the start of C printing are done.

In step S100, settings necessary to start C printing are done.

Instep S110, LUT A and RAM A are used to execute C printing. During this period, LUT B and RAM B used in the next K printing are set (data are written or rewritten).

In step S120, C printing end processing is performed.

In step S130, settings before the start of K printing are done.

In step S140, settings necessary to start K printing are done.

In step S150, LUT B and RAM B are used to execute M printing.

In step S160, K printing end processing is performed.

This embodiment decreases the number of LUTs or RAMs to two from four in the prior art. Required performance such as the processing speed is satisfied, whereas the number of gates and the capacity are decreased, reducing the power consumption and cost.

The above-described embodiment is merely an example, and does not limit the present invention. The present invention can be variously modified within the technical scope of the appended claims. For example, in the above embodiment, the data conversion LUTs for correction of image data, the toner density conversion LUTs, and test pattern saving RAMs have been exemplified as LUTs and RAMs which require different settings for respective colors. The present invention is not limited to this, and may be applied to other LUTs and RAMs such that two LUTs and two RAMs are adopted, alternately switched, and set.

The present invention is not always applied to all LUTs and RAMs which require different settings for respective colors. The present invention can be applied to at least any one of the γ correction data conversion LUT, toner density conversion LUT, and test pattern saving RAMs, or two of them.

As for an LUT or RAM which hardly influences the processing speed, only one LUT or RAM is adopted, and switched and set for each color.

In the circuit arrangement shown in FIG. 3, data is supplied from the CPU 300 directly to the LUT or RAM via the CPU I/F and written. It is also possible to select either of the LUTs 22A and 22B, the LUTs 50A and 50B, or the RAM 90A and 90B by a multiplexer or selector and alternately write data in the LUTs 22A and 22B, the LUTs 50A and 50B, or the RAM 90A and 90B.

What is claimed is:

1. An image forming circuit which receives input image data, performs image processing necessary to form a color image, and outputs print image data necessary for printing, comprising:
an image processor which receives the image data, and performs γ conversion processing for respective Y, M, C, and K colors by using a γ conversion LUT rewritten in accordance with the respective colors; and
a print area controller which receives the image data having undergone the γ conversion processing, and generates and outputs the print image data.

2. An image forming circuit which receives input image data, performs image processing necessary to form a color image, and outputs print image data necessary for printing, comprising:
an image processor which receives the image data, and performs γ conversion processing for respective Y, M, C, and K colors by alternately using two γ conversion LUTs; and
a print area controller which receives the image data having undergone the γ conversion processing, and generates and outputs the print image data.

3. A circuit according to claim 2, wherein
the image forming circuit further comprises a density converter which receives the print image data, and uses two density conversion LUTs for density conversion processing necessary to obtain a consumed toner amount, and
said density converter alternately uses the two density conversion LUTs when performing density conversion processing for the respective Y, M, C, and K colors.

4. A circuit according to claim 2, wherein the image forming circuit further comprises a test pattern generator which uses two test pattern saving RAMs to generate a test pattern necessary to print a test pattern, and outputs the test pattern as the image data to said image processor, and
said test pattern generator alternately uses the two test pattern saving RAMs when generating test patterns in the respective Y, M, C, and K colors.

5. An image forming apparatus comprising a scanner which scans an original and outputs image data, an image forming circuit which receives the image data, performs image processing necessary to form a color image, and outputs print image data necessary for printing, and a laser scan unit which receives the print image data and scans a laser beam,
said image forming circuit having
an image processor which receives the image data, and performs γ conversion processing for respective Y, M, C, and K colors by alternately using two γ conversion LUTs, and
a print area controller which receives the image data having undergone the γ conversion processing, and generates and outputs the print image data.

6. An image forming method of receiving input image data, performing image processing necessary to form a color image, and outputting print image data necessary for printing, comprising the steps of:
receiving the image data to perform γ conversion processing for respective Y, M, C, and K colors by alternately using two γ conversion LUTs; and
receiving the image data having undergone the γ conversion processing to generate and output the print image data.
